(19) United States
(12) Patent Application Publication
(10) Pub. No.: US 2017/0129697 A1
(43) Pub. Date: May 11, 2017

(54) INTERCONNECT FOR FREIGHT CONTAINERS

(71) Applicant: Duraloc Limited, Thirsk, Yorkshire (GB)

(72) Inventor: Stephen Reynard, Yorkshire (GB)

(21) Appl. No.: 15/316,983

(22) PCT Filed: Jun. 4, 2015
(86) PCT No.: PCT/GB2015/051631

§ 371 Date: Dec. 7, 2016

(30) Foreign Application Priority Data
Jun. 9, 2014 (GB) 1410153.9

(51) Int. Cl. B65D 90/00; F16B 2/10

(52) U.S. Cl. CPC B65D 90/0013; F16B 2/10

(57) ABSTRACT

An interconnector (400) for coupling two corner units of adjacent ISO freight containers in an end-to-end or side-to-side configuration, wherein each of the corner units is able to receive a part of the interconnector. The interconnector (400) comprises a main body (401) with an internal chamber (405) inside. A first clamp head (404) and a second clamp head (409) are positioned at opposite ends (402, 403) of the main body (401) and a shaft (408) is rotatably mounted within the internal chamber (405). The first clamp head (404) is substantially hook shaped and is provided in a fixed position relative to the main body (401), whilst the second clamp head (409) is fixed to one end of the shaft (408) and is able to rotate with the shaft (408). A bias actuator works to bias the rotation of the shaft (408) and the second clamp head (409) relative to the main body (401) to prevent accidental decoupling of the containers.

### FIELD OF INVENTION

The present invention relates to an interconnector for coupling two corner units of adjacent ISO freight containers in an end-to-end or side-to-side arrangement.

### BACKGROUND ART

Standard freight containers typically have eight corner units which allow the container to be joined to another container in a variety of spatial arrangements. A corner unit generally comprises a hollow frame having several apertures which may be used to engage with an interconnector and couple one freight container to another adjacent freight container. The interconnectors are usually held in position by clamp heads which may form a “twistlock” connection. The clamp head is positioned through one of the apertures of the corner unit and is rotated into a locked position within the corner unit to form a secure connection.

The freight containers may be stacked one on top of the other, or positioned end-to-end or side-to-side. It is often desirable to couple multiple containers together to allow them to be lifted by ship to shore cranes as one larger unit. For example, two ten feet containers may be coupled together to form a twenty feet unit. Significant costs are involved in shipping freight containers, partly due to the port-side crane lifts which are normally charged at a cost per lift. Accordingly, if multiple containers can be assembled together to form one larger unit, this reduces the cost of lifting cargo to and from shore during loading and unloading operations.

Depending on the spatial arrangement in which the containers must be coupled, specialist interconnectors may be used. These types of interconnectors are generally positioned through the side-facing apertures of two corner units on adjacent containers. The connection between the containers must be robust and strong enough to withstand shear, bending, compression and tensile forces to which it may be subjected to in service. A certain amount of “play” in the engagement between the interconnector and the corner units can be tolerated.

During handling, there are often problems associated with small misalignments in the initial securements of the corner units to the outer walls of the container. To minimise such problems, the corner units are welded in position at the junction between each horizontal and vertical outer frame component to ensure that each outer face of a corner unit is substantially parallel to the outer wall of the freight container to which it is adjacent.

By way of example, various interconnectors are disclosed in U.S. Pat. No. 4,626,155, EP 2147874, WO 03106298, GB 2390360 and U.S. Pat. No. 5,193,253.

A particular problem with existing interconnectors is that because the apertures of the corner units are different sizes to one another, certain clamp heads such as conventional T-shaped “twistlocks” are not suitable for safe coupling of containers. This is because the contact area between the T-shaped clamp head when in the locked position and the corner unit is not sufficient to transmit the loads imposed. In certain circumstances, the “twistlocks” may fall out of position or become loose. This poses a significant health and safety risk to the operators who handle the coupled containers during loading and unloading operations.

To overcome these problems, various multi-part components have been produced. Such interconnectors typically comprise threaded stems that are attached to locking blocks with suitable threaded holes which are placed inside the corner unit through the largest aperture. Other interconnectors have clamping components that are positioned through the largest aperture and then pinned or bolted in a body on the exterior. However such interconnectors are complex and difficult to install with a risk of losing the smaller components during handling. Accordingly, what is required is an interconnector that solves these problems.

### SUMMARY OF THE INVENTION

It is an objective of the present invention to provide safe and secure coupling between two corner units of adjacent ISO freight containers that are to be assembled in an end-to-end or side-to-side arrangement to allow unified suspension i.e., dockside raising and lowering, by suitable lifting cranes and the like.

Accordingly, the objectives are achieved by the present interconnector that comprises a hook shaped clamp head at one end of a main body which can be inserted through at least one aperture in the corner unit of one ISO container and braced into position. At the other end of the main body of the interconnector is an L-shaped “twistlock” which can be inserted into a corresponding aperture of a corner unit on an adjacent ISO container. The L-shaped “twistlock” is then rotatable through approximately 90° into a locked position to provide a secure connection of the two containers. Such an arrangement provides a sufficient area of contact between the interconnector and the corner unit to safely transmit the loads imposed during handling.

According to the first aspect of the present invention there is provided an interconnector for coupling two corner units of adjacent ISO freight containers in an end-to-end or side-to-side arrangement, wherein each of the corner units comprises a hollow frame with an aperture which is able to receive a part of the interconnector within the frame, the interconnector comprising: a main body having a first end, a second end and an internal chamber extending from the second end towards the first end; a rotatable shaft mounted within the internal chamber; a first clamp head located substantially at the first end of the main body and a second clamp head located substantially at the second end of the main body; wherein the second clamp head is fixed to one end of the shaft and is configured to rotate with the shaft; and a bias actuator to bias rotation of the shaft and the second clamp head relative to the main body; wherein the first clamp head is substantially hook shaped and is provided in fixed position relative to the main body.

This configuration advantageously provides safe coupling of ISO freight containers in an end-to-end or side-to-side arrangement. There is provided sufficient contact area between the interconnector and the corner unit to safely transmit the loads imposed during handling. Specifically, the hook region of the first clamp head may be safely braced into position between an upper aperture and side aperture of a corner unit without the risk of it falling out or becoming loose once the second clamp head has been rotated into a locked position within the corner unit of an adjacent container. As the first clamp head is in a fixed position relative to the main body, it is not able to move independently and there is no risk of component parts being lost as with conventional interconnectors. The present interconnector is also efficient to manufacture as the first clamp head is part of the structure of the main body. Such an interconnector advantageously allows several freight containers to be coupled together so that they can be manoeuvred as one unit, thereby facilitating handling and reducing the costs involved with port-side cranes to load and unload containers from ships as such charges are normally incurred per lift.

Optionally, the first clamp head further comprises: a lower hook region which is substantially wedge shaped and an upper hook region which is substantially cube shaped. Such an arrangement is advantageous to ensure there is a close fit between the lower hook region and the side aperture of the corner unit and the upper hook region and the upper aperture of the corner unit. Such a close fit arrangement means that the first clamp head can be safely “braced” into position without the risk of it becoming loose.

Optionally, the lower hook region extends axially from the main body by a length E and the upper hook region extends upwardly and outwardly from the lower hook region by a height A.

Advantageously, length E provides sufficient length for the lower hook region to extend axially towards the area in which the upper aperture is accessible by the upper hook region which extends upwardly and outwardly from the lower hook region by a height A. The degree of protrusion of the upper hook region by height A is sufficient to ensure that the upper hook region is inserted within the upper aperture of the corner unit. This advantageously provides a secure connection between the interconnector and the corner unit.

Optionally, the lower hook region further comprises: an upper surface; a lower surface; and two side surfaces; wherein the upper surface is substantially parallel to a longitudinal axis of the main body, the lower surface is oriented at approximately 45° to the longitudinal axis and the two side surfaces are substantially perpendicular to the upper surface. Such an arrangement is advantageous as the hook shaped first clamp head can be easily inserted into the side aperture of the corner unit and rotated into position so that the upper hook region engages with the upper aperture and part of the lower hook region is housed within the side aperture of the corner unit.

Optionally, the upper surface of the lower hook region extends axially from the main body by a length C which is approximately 50% of length E. This configuration provides easy insertion of the hook shaped first clamp head into the upper aperture and side aperture of the corner unit.

Optionally, the upper and lower surfaces of the lower hook region are separated by a height B and the two side surfaces are separated by a width D, wherein width D is approximately 85% of height B. Advantageously, such a configuration provides a close fit between lower hook region and the side aperture of the corner unit so that there is minimal risk of the interconnector becoming loose or falling out of the side aperture.

Optionally, length C is approximately 70% of width D. Such an arrangement advantageously reduces the chances of the interconnector falling out of the side aperture or becoming loose because the dimensions of the lower hook portion provide a close fit within the side aperture of the corner unit.

Optionally, the height A is approximately 60% of height B and 70% of width D. Advantageously, such a configuration provides a close fit between lower hook region within the side aperture of the corner unit so that there is minimal risk of the interconnector becoming loose or falling out of the side aperture.

Optionally, the upper surface, lower surface and two side surfaces of the lower hook region are substantially planar and form abutment surfaces which are able to make contact with an internal surface of a side aperture of the corner unit when the first clamp head is inserted into the corner unit. Such an arrangement is advantageous because the contact area between the upper surface, lower surface and two side surfaces of the lower hook region and the internal surface of the side aperture is sufficient to withstand the forces imposed upon the structure during use, for example, the loading and unloading of coupled freight containers from ships using port-side cranes.

Optionally, the upper hook region comprises: a radial extension of the lower hook region in the form of a protrusion oriented substantially perpendicular to the upper surface of the lower hook region. Advantageously, such a configuration provides a secure connection between the upper hook region and the upper aperture of the corner unit.

Optionally, the upper hook region further comprises: an upper surface; and four side surfaces; wherein the upper surface and four side surfaces are substantially planar and one of the side surfaces is an extension of the upper surface of the lower hook region. Such an arrangement advantageously provides a sufficient area of contact between the internal surface of the upper aperture and the upper hook region so that the loads can be safely transmitted in use.

Optionally, another one of the side surfaces is an extension of the lower surface of the lower hook region. This configuration provides the lower hook region and upper hook region to be formed as one unit which is rigidly formed as part of the main body. This enables the first clamp head and main body to be manufactured efficiently as a single unit and to provide a robust interconnector.

Optionally, three of the four side surfaces of the upper hook region form abutment surfaces which are able to make contact with the internal surface of the upper aperture of the corner unit when the first clamp head is inserted into the corner unit. Advantageously, the three side surfaces of the upper hook region provide sufficient contact area with the internal surface of the upper aperture when the first clamp head is in position. This allows the loads to be safely transmitted during use.

Optionally, the second clamp head is aligned offset from a longitudinal axis of the shaft. Such an arrangement is advantageous as the offset nature of the second clamp head from the longitudinal axis provides a sufficient amount of contact area between the internal wall of the corner unit and the base of the second clamp head when the second clamp head is rotated into the locked position.

Optionally, the second clamp head further comprises: a dome shape profile having a substantially planar base; wherein the second clamp head in combination with an end part of the shaft define an L-shaped twistlock arrangement. This configuration advantageously provides a second clamp head which is shaped to be easily inserted into the side aperture of a corner unit. This provides that the second clamp head can be quickly placed in position without the risk of components becoming misaligned thereby saving the time of the operators so that they may work more efficiently.

Optionally, the substantially planar base of the second clamp head forms an abutment surface which is able to make contact with an internal wall of the corner unit when the second clamp head is rotated in a locked position. This configuration advantageously provides a sufficient amount of contact area between the internal wall of the corner unit and the base of the second clamp head when the second clamp head is rotated into the locked position. This enables the interconnector to withstand the loads imposed during use, for example the unloading and loading of containers from ships using port-side cranes.

Optionally, the interconnector further comprising: a slot extending radially through the main body and aligned perpendicular to the shaft; and an actuator arm projecting from the shaft and radially outward through the body via the slot, the actuator arm capable of reciprocating movement within the slot to provide rotation of the as the shaft and the second clamp head. Such an arrangement advantageously provides the position of the second clamp head to be easily moved via the use of an actuator arm.

Optionally, the actuator arm comprises a handle movably mounted in a circumferential direction about the main body through the slot. This configuration provides a handle which can be easily grasped and moved by the operator in order to cause rotation of the actuator arm through the slot and movement of the shaft and second clamp head into position. This allows the operator to quickly unlock and lock the second clamp head into place, thereby saving time and increasing efficiency.

Optionally, the handle further comprises a first bias actuator positioned to bias the handle in a direction towards the main body. Advantageously, the first bias actuator provides a safety mechanism for the operator to ensure that the handle is biased in a direction towards the main body to prevent accidental movement of the handle and potential decoupling of the freight containers via rotation of the second clamp head into the unlocked position.

Optionally, the first bias actuator of the handle comprises a coil spring housed within an internal cavity of the handle, wherein a first end of the spring is attached to the handle and a second end of the spring is attached to the actuator arm. Advantageously, the spring acts to bias the handle in the direction of the main body so as to provide a safety mechanism for the operator to prevent accidental movement of the handle and potential unlocking of the second clamp head and decoupling of the freight containers.

Optionally, the handle comprises a protrusion and the main body comprises a complementary shaped recess, so that the protrusion is able to fit within the recess and prevent movement of the handle. Such an arrangement is advantageous as the complementary shaped protrusion and recess provide a latch component which safely allows the operator to release the handle to move the actuator arm within the slot and also provides a secure position in which the protrusion sits within the recess to prevent accidental movement of the handle and possible decoupling of the freight containers by movement of the second clamp head into the unlocked position.

Optionally, a second bias actuator comprises a spring attached at one of its ends to the main body and at the opposite end to the actuator arm. This configuration provides a second safety feature to protect the operator from accidental decoupling of the freight containers as the torque force exerted by the spring must be overcome to move the second clamp head from the locked position to the unlocked position. The second bias actuator works to bias the second clamp head into a locked position, thereby reducing the risk of accidental decoupling.

Optionally, the second bias actuator spring is oriented in the internal chamber of the main body and extends circumferentially around the shaft between an internal facing surface of the main body and an outer surface of the shaft. Advantageously, the second bias actuator works to bias the second clamp head into a locked position, thereby reducing the risk of accidental decoupling and acting as a safety device for the operators.

### BRIEF DESCRIPTION OF DRAWINGS

A specific implementation of the present invention will now be described, by way of example only, and with reference to the accompanying drawings in which:

FIG. 1 is a perspective view of two adjacent freight containers clamped together via the interconnector in an end-to-end configuration to form a composite assembly suitable for unitary handling according to one aspect of the present invention;

FIG. 2 is a perspective view of four adjacent freight containers which are clamped together via the interconnector in a side-to-side configuration to form a composite assembly suitable for unitary handling according to a specific implementation of the present invention;

FIG. 3 is a perspective view of a corner unit which is positioned at each corner of the freight containers shown in FIGS. 1 and 2, the corner unit comprising apertures which are able to receive a clamp head of the interconnector according to one aspect of the present invention;

FIG. 4 is a side view of an interconnector according to one aspect of the present invention having two clamp heads positioned at each end of the main body;

FIG. 5 is an end view along a longitudinal axis of the hook shaped first clamp head of the interconnector shown in FIG. 4;

FIG. 6 is an end view along a longitudinal axis of the L-shaped “twistlock” second clamp head of the interconnector shown in FIG. 4;

FIG. 7 is a plan view along a transverse axis of the interconnector shown in FIG. 4;

FIG. 8 is an end view along a longitudinal axis of the L-shaped “twistlock” second clamp head of the interconnector shown in FIG. 4 wherein the clamp head is rotated into the locked position;

FIG. 9 is an end view along a longitudinal axis of the L-shaped “twistlock” second clamp head of the interconnector shown in FIG. 4 wherein the clamp head is rotated into the unlocked position; it is in the unlocked position that the clamp head is inserted into the aperture of the corner unit;

FIG. 10 is a side view of the interconnector shown in FIG. 4 locked into position in one corner unit via the hook-shaped first clamp head;

FIG. 11 is a side view of the interconnector shown in FIG. 4 locked into position in two corner units via the first and second clamp heads;

FIG. 12 is a cross sectional view through the main body showing the bias actuator housed within the internal chamber and circumferentially around the shaft;

FIG. 13 is a side view of the interconnector as shown in FIG. 4 illustrating the dimensions of various aspects of the interconnector; and

FIG. 14 is a plan view of the interconnector as shown in FIG. 5 illustrating the dimensions of various aspects of the interconnector.

### DETAILED DESCRIPTION OF PREFERRED EMBODIMENT OF THE INVENTION

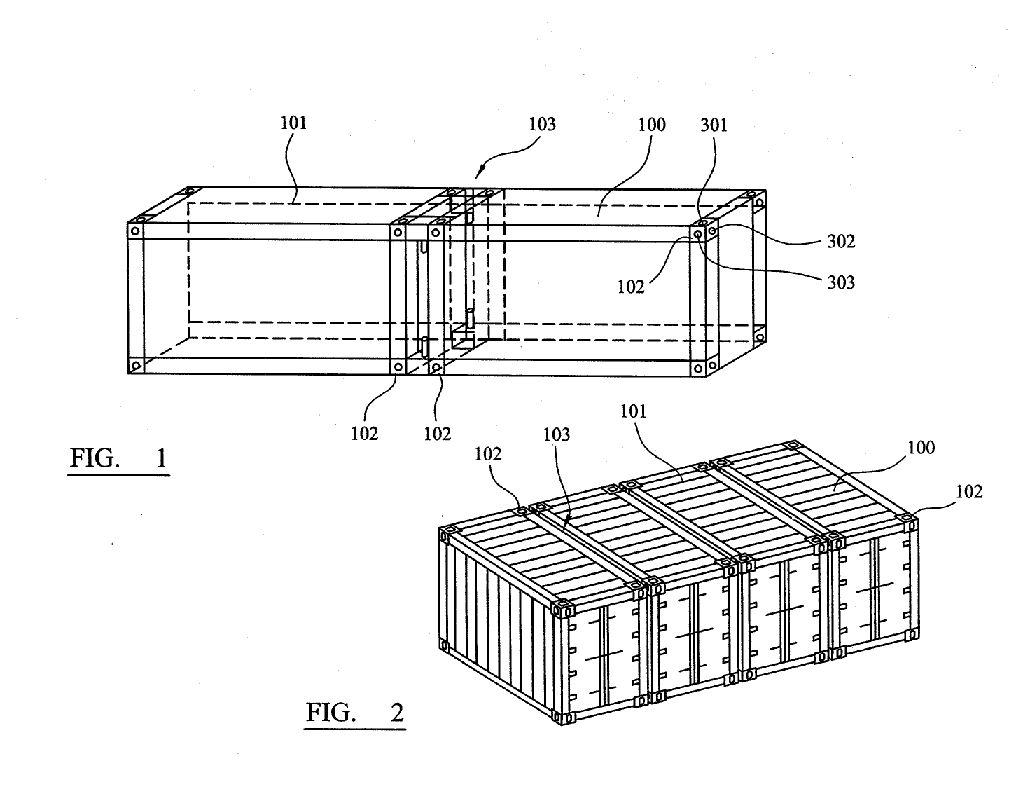

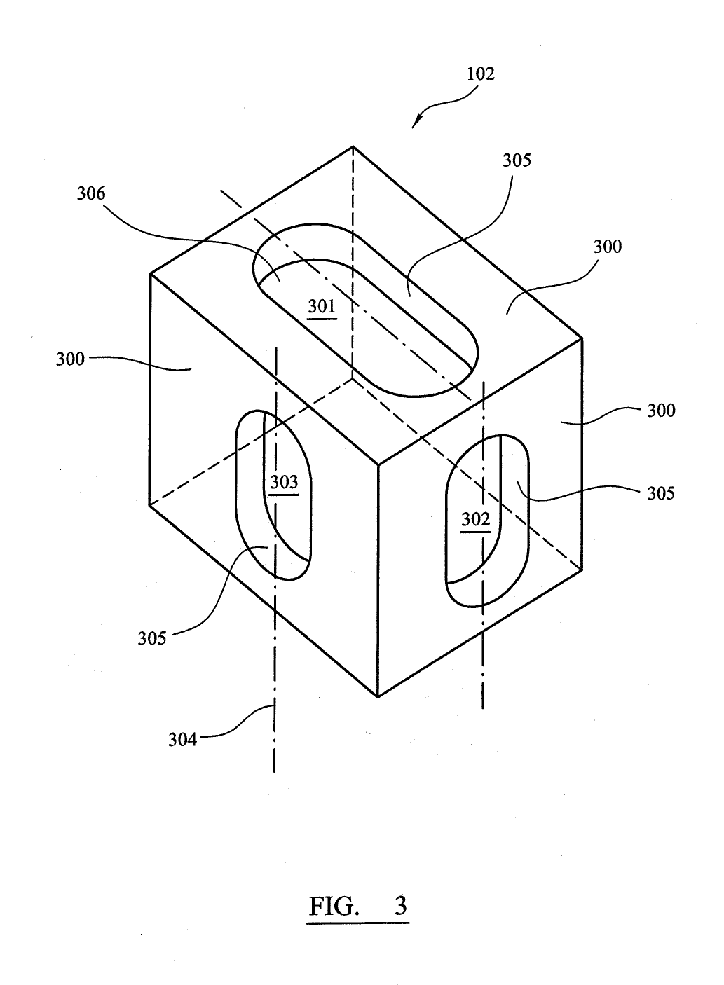

According to an embodiment of the present invention, referring to FIG. 1, the interconnector couples a first freight container 100 to an adjacent second freight container 101 in an end-to-end arrangement to form a unitary assembly which is suitable for being handled as a large singular unit for operations such as loading, unloading and storage. FIG. 2 illustrates the present interconnector used in an alternative arrangement to couple together adjacent freight containers in a side-to-side configuration. For example, two smaller containers may be coupled together to form one 6.1 m (twenty feet) ISO module. It is advantageous to couple freight containers together to form one larger unit which can be handled as a singular assembly in order to reduce the costs associated with the loading and unloading of cargo from ships by port-side cranes. The port-side cranes which are employed to load and unload the cargo ships usually charge per lift and so operating costs can be expensive if multiple freight containers are not advantageously consolidated via coupling into one larger unit. The time taken for loading/unloading is also reduced.

Referring to FIG. 1, freight containers 100, 101 are generally elongate hollow cuboidal structures provided with corner units 102 positioned at each vertex, so that a total of eight corner units are provided on any one container. Referring to FIGS. 1 to 3, corner unit 102 comprises a hollow body 300 with three apertures 301, 302, 303 which extend through the three respective walls of corner unit 102. Apertures 301, 302, 303 are defined by an inner surface 305 which is formed in part by a pair of substantially parallel opposed edges which are connected to one another by means of a substantially semi-circular arc. FIG. 1 illustrates the position of apertures 301, 302, 303 in relation to freight container 100. Specifically, upper aperture 301 is provided facing outwardly away from the upper surface of container 100 and side apertures 302, 303 are provided facing outwardly away from the side surfaces of container 100. Upper aperture 301 is typically larger than side apertures 302, 303.

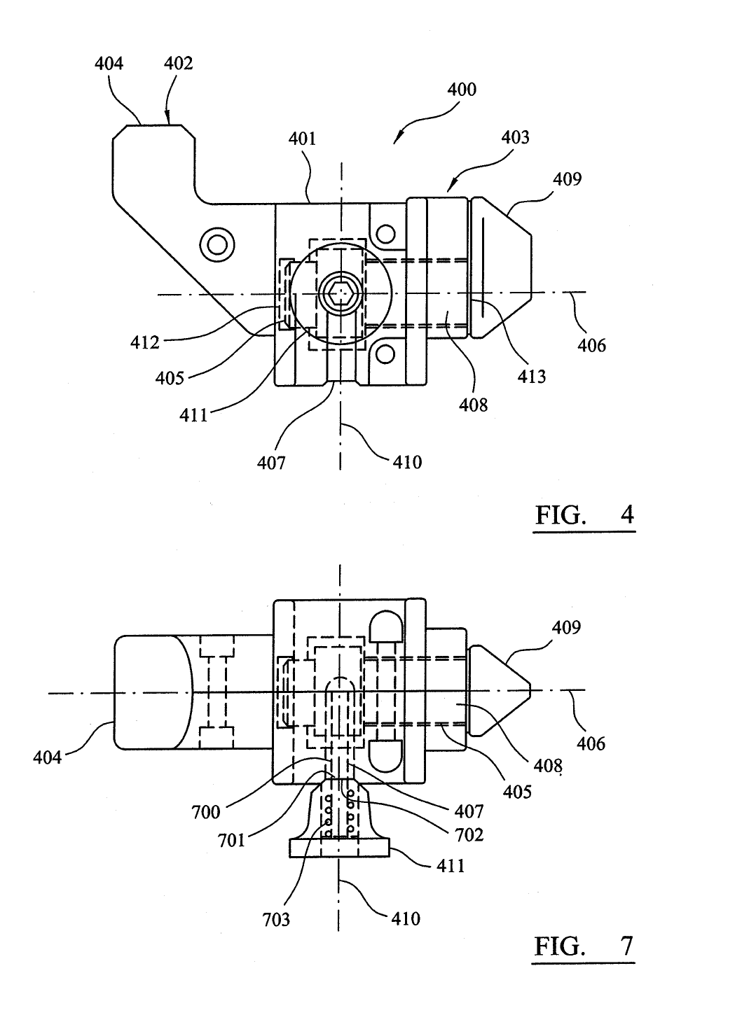

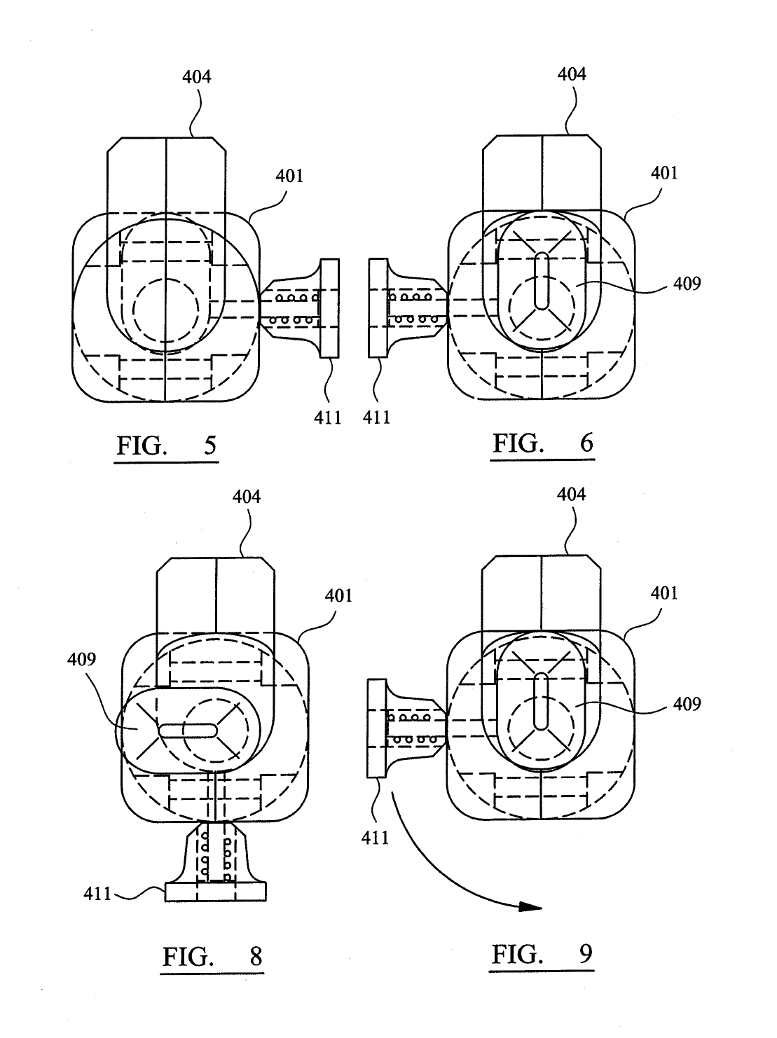

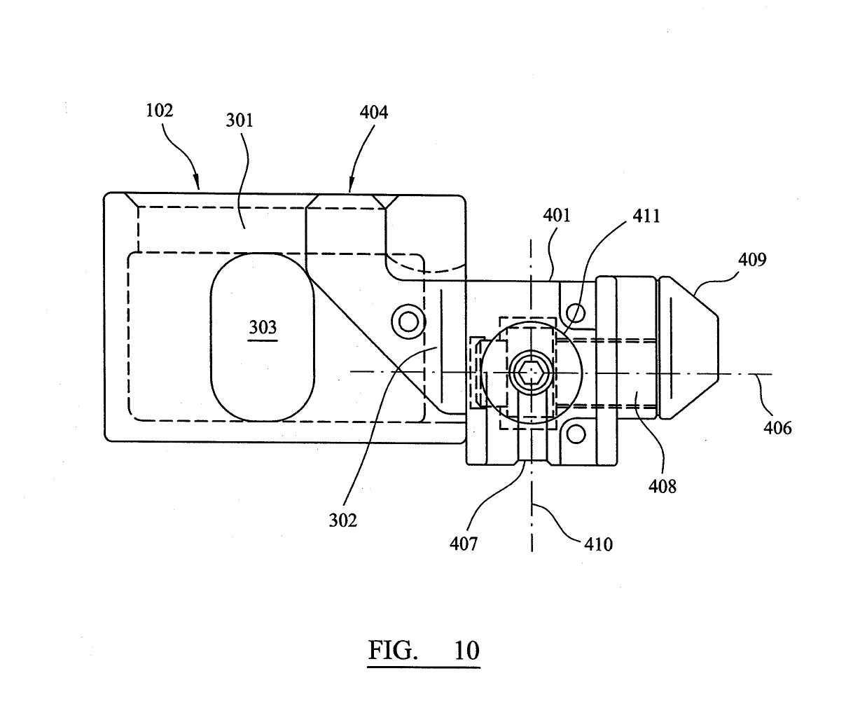

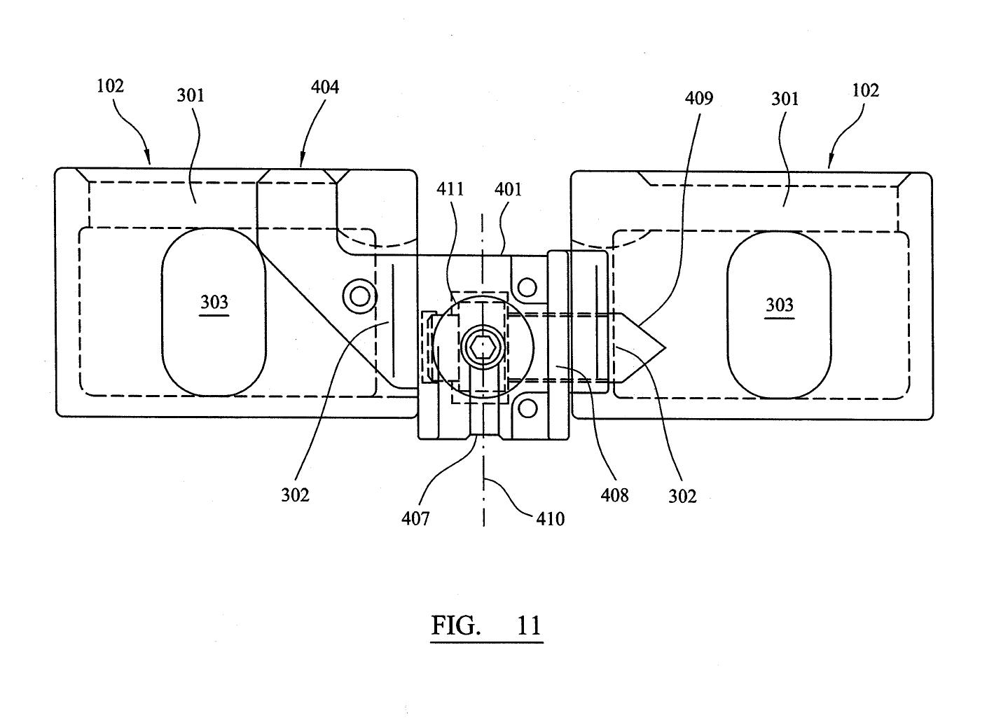

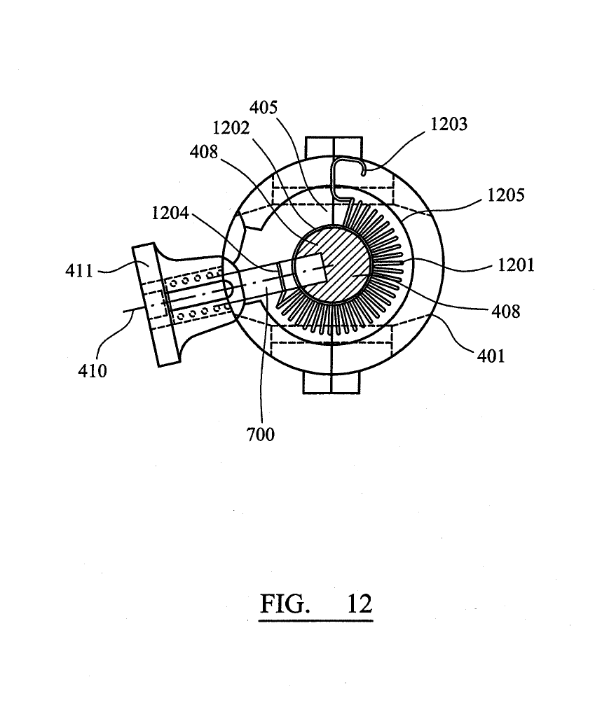

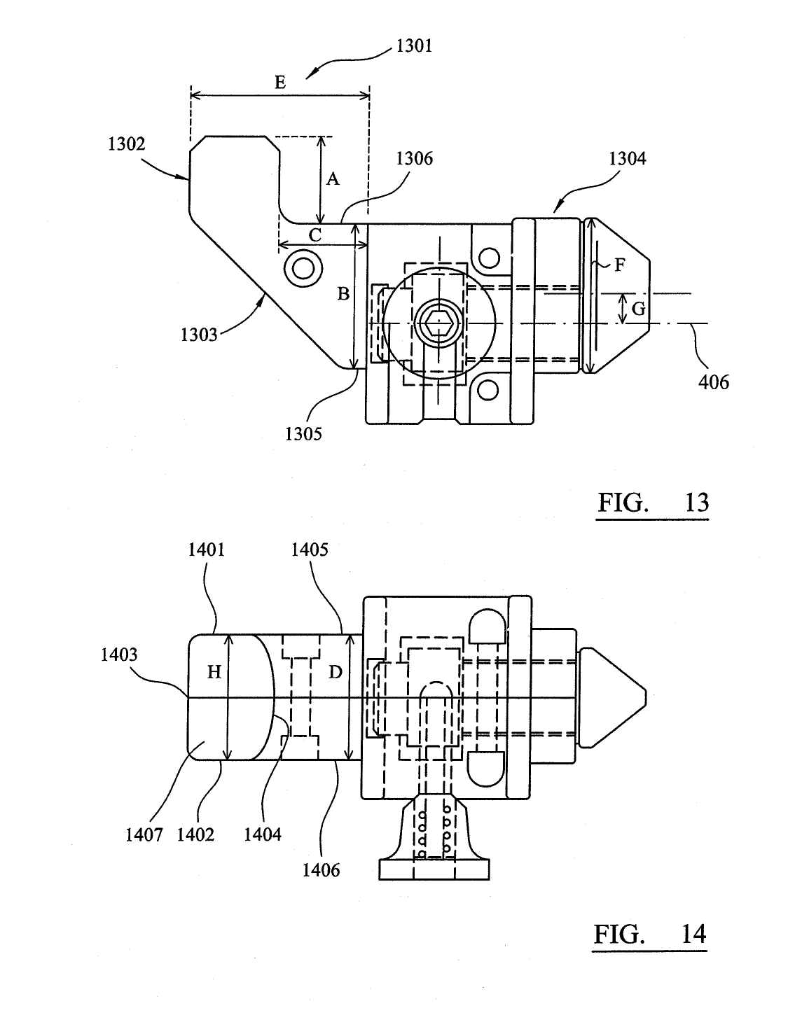

Referring to FIGS. 4 to 14, interconnector 400 comprises a main body 401 with a first end 402 and a second end 403. Specifically, first end 402 comprises a first clamp head 404 which is substantially hook shaped and rigidly formed as part of main body 401 so that it cannot be moved independently of main body 401. Additionally, first clamp head 404 comprises a hook region 1301 which is formed from a lower hook region 1303 and an upper hook region 1302.

Lower hook region 1303 is substantially wedge shaped and extends axially from the central part of main body 401. In particular, lower hook region 1303 is formed from an upper surface 1306, a lower surface 1305 and side surfaces 1405, 1406 which are substantially planar and form abutment surfaces when the first clamp head 404 is inserted into position within side aperture 302 of unit 102. Lower surface 1305 extends axially from the central part of the main body 401 by a length E, specifically along an inclined gradient of approximately 45° to a longitudinal axis 406 to form a tapered outer portion of lower hook region 1303. Upper surface 1306 extends axially from the central part of main body 401 substantially parallel to the longitudinal axis 406 by a length C which is approximately 50% of length E. Upper and lower surfaces 1306, 1305 are connected by side surfaces 1405, 1406 which are aligned substantially perpendicular to upper surface 1306. Additionally, upper surface 1306 is separated from the lower surface 1305 by a maximum height B wherein the upper and lower surfaces 1306, 1305 originate from the central part of main body 401. The distance by which upper and lower surfaces 1306, 1305 are separated becomes gradually less the further removed from the central part of the main body 401 in the axial direction. This is due to the approximately 45° gradient at which lower surface 1305 is orientated relative to upper surface 1306 to form a wedge shape. Side surfaces 1405, 1406 are spaced apart by a width D which is approximately 85% of height B. Additionally, dimensions B, C and D form a close fit within side aperture 302 to provide a secure connection between the unit 102 and interconnector 400.

Upper region 1302 is formed as an extension of lower region 1303 in a radial direction away from the main body 401. Furthermore, upper region 1302 is substantially cube shaped and protrudes upwardly and outwardly from the main body 401 and substantially perpendicular to upper surface 1306 of lower region 1303. Additionally, upper region 1302 is formed from an upper surface 1407 and side surfaces 1401, 1402, 1403, 1404 which are substantially planar. As the dimensions of upper aperture 301 of corner unit 102 are larger than side aperture 302, only three of the four side surfaces 1401, 1402, 1404 of upper region 1302 form abutment surfaces when first clamp head 404 is engaged within upper aperture 301 and interconnector 400 is “braced” into position. Upper region side surface 1404 is formed as an extension of the lower region upper surface 1306 and extends substantially perpendicular to upper surface 1306 at a length C from the central part of main body 401. Additionally, upper region side surface 1404 extends upwardly and outwardly from lower region upper surface 1306 by a height A which is approximately 60% of height B and 70% of the width D. Upper region side surface 1403 is an extension of lower region lower surface 1305 by an axial length E from the central part of main body 401. Furthermore, side surface 1403 is aligned substantially parallel to side surface 1404 having a height A. Side surfaces 1401, 1402 of upper region 1302 are extensions of side surfaces 1405, 1405 of lower region 1303 by height A and are separated by a width H which is approximately equal to width D of lower region 1303.

As the hook shaped first clamp head 404 is inserted into apertures 302 and 301, lower region 1303 is engaged within side aperture 302 and the upper region 1302 is inserted into position within upper aperture 301. Upper surface 1306, lower surface 1305 and side surfaces 1405, 1406 of lower region 1303 substantially abut the inner surface 305 of side aperture 302, whilst side surfaces 1402, 1402, 1404 of the upper region 1302 are in contact with a substantial part of the inner surface 305 of upper aperture 301. The degree of contact area between these abutment surfaces provides a secure connection between the unit 102 and interconnector 400 sufficient to safely transmit the loads imposed during use, for example the loading and unloading of consolidated shipping containers via port-side cranes.

Main body 401 further houses a substantially cylindrical internal chamber 405 which extends axially along longitudinal axis 406 from the first end 402 to the second end 403 of main body 401. Additionally, internal chamber 405 comprises a first end 412 which forms an abutment surface and a second end 413 which provides an aperture in the second end 403 of main body 401. Furthermore, internal chamber 405 houses a shaft 408 which is substantially elongate and cylindrical. Shaft 408 is rotatably mounted within internal chamber 405 and extends axially from the first end 412 of internal chamber 405 through the aperture at the second end 413 of internal chamber 405 so that shaft 408 protrudes beyond the second end 403 of main body 401. Additionally, suitable bearings (not shown) are accommodated within the internal chamber 405 to enable shaft 408 to rotate freely.

A second clamp head 409 is provided independent of the structure of the main body 401 at main body second end 403. Additionally, second clamp head 409 is formed at the protruding end of shaft 408 and may be integral to the structure of shaft 408 through casting, or alternatively attached as an independent member through welding or bolting. Furthermore, second clamp head 409 is offset from the longitudinal axis 406 by approximately 15% of a length F of the second clamp head 409 and is formed as an L-shaped “twistlock”. Specifically, second clamp head 409 is substantially dome shaped with a substantially planar base and a tapered (domed) end region to facilitate insertion of the head 409 into side aperture 302. Rotation of shaft 408 about longitudinal axis 406 causes reciprocal rotation of second clamp head 409, so that the substantially planar base of second clamp head 409 provides an abutment surface s contact with the substantially planar internal wall 306 of corner unit 102 in the locked position as shown in FIG. 8. The offset alignment of the second clamp head 409 from longitudinal axis 406 provides a large contact area between the base of second clamp head 409 and the substantially planar inside wall 306 of corner unit 102 in the locked position. The degree of contact area is sufficient to safely transmit the loads imposed during unloading and loading of combined shipping containers using port-side cranes.

Referring to FIGS. 4 to 14, the main body 401 of interconnector 400 further comprises a hollow slot 407 which extends radially outwardly from internal chamber 405 to define an aperture in the main body 401. Shaft 408 further comprises an actuator arm 700 which extends radially outwardly from shaft 408 through slot 407 and protrudes beyond the main body 401 to form a handle 411. Actuator arm 700 is substantially cylindrical and is connected at one end to shaft 408 and at the other end to handle 411 which further comprises a widened region at the outermost facing surface capable of being grasped and manoeuvred by an operator. Movement of handle 411 circumferentially about the main body 401 causes reciprocal movement of actuator arm 700 through slot 407. This movement provides rotation of shaft 408 about longitudinal axis 406 which in turn causes rotation of second clamp head 409 located externally of main body 401. Furthermore, handle 411 comprises a protrusion 702 at the inner surface which is adjacent to the outer surface of main body 401. Additionally, a recess 701 is provided in the outer surface of main body 401 that is complementary in shape to handle protrusion 702 so that the protrusion 702 and recess 701 fit together to form a latch component which prevents handle 411 from being moved unintentionally. A first bias actuator is located within the internal housing of handle 411 in the form of a coil spring 703 which is attached at one end to handle 411 and at the other end to actuator arm 700. The first bias actuator acts to bias protrusion 702 of handle 411 into recess 701 of main body 401 to secure the location of handle 411 and prevent the handle 411 from being moved. In order to disengage the latch component from the biased position and move handle 411 to another position about the main body 401, handle 411 must be manually pulled in an outward direction away from main body 401 to release protrusion 702 from recess 701. The handle 411 may then be moved in a circumferential direction about main body 401 to move actuator arm 700 through slot 407. Movement of actuator arm 700 causes rotation of shaft 408 within the internal chamber 405 and reciprocal movement of second clamp head 409.

Referring to FIG. 12 a second bias actuator is housed within internal chamber 405 of main body 401. The second bias actuator is in the form of a coil spring 1201 which extends circumferentially around the outer surface 1202 of shaft 408. Furthermore, a first end of the spring 1203 is attached to main body 401 and a second end of the spring 1204 is attached to actuator arm 700. Additionally, spring 1201 is configured to bias the position of actuator arm 700 and accordingly shaft 408 and second clamp head 409 into a locked position as shown in FIG. 8, with movement into the unlocked position as shown in FIG. 9 being against the torque force exerted by the spring 1201. First and second bias actuators advantageously provide additional safety features for the operators handling the coupled freight containers to minimise any accidental de-coupling of the containers during loading, unloading or storage operations.

Referring to FIGS. 1 to 14, interconnector 400 couples together two corner units 102 of adjacent freight containers 100, 101 either in an end-to-end configuration or a side-to-side configuration. The hook shaped first clamp head 404 is positioned through side aperture 302 of the unit 102 and engages with upper aperture 301 of the unit 102. Inner surfaces 305 of apertures 301, 302 are in contact with part of the outer surface of first clamp head 404 when the interconnector 400 is in place. An advantage of the hook shaped first clamp head 404 is that it overcomes the problems associated with conventional T-shaped clamp heads which are typically used as interconnectors for this type of freight container arrangement. For example, T-shaped clamp heads are usually too small to be securely fixed through the apertures of the corner unit 102 and are susceptible to falling out or becoming loose. This poses a significant safety risk to the operators who handle the coupled freight containers during loading and unloading operations. The hook shaped clamp head 404 advantageously allows the interconnector 400 to be braced into position inside upper aperture 301 and side aperture 302. Sufficient contact area between the inner surfaces 305 of apertures 301, 302 and first clamp head 404 provide a secure connection between the interconnector 400 and corner unit 102.

Once first clamp head 404 is in position in the corner unit 102 of one freight container, the second clamp head 409 is rotated into the unlocked position as shown in FIG. 9 to allow the passage of second clamp head 409 through side aperture 302 of another corner unit 102 of an adjacent freight container 101. The protruding region 1304 of the second end 403 of main body 401 sits comfortably within side aperture 302 of the second corner unit 102 and the inner surface 305 of aperture 302 is substantially in contact with the outer surface of the protruding region 1304 of main body 401. To secure the connection between the two adjacent freight containers 100, 101, second clamp head 409 is rotated approximately 90° anticlockwise in the direction of the arrow shown in FIG. 9 to the locked position shown in FIG. 8. This is achieved by releasing the latch mechanism on handle 411 and the main body 401 by pulling handle 411 in an outward direction away from main body 401 so that the torque exerted by spring 703 is overcome and the handle 411 free to move by the operator in an anticlockwise circumferential direction approximately 90° about main body 401. This action causes actuator arm 700 to move approximately 90° through slot 407 to the locked position and causes reciprocal rotation of shaft 408 within internal chamber 405 and movement of the second clamp head 409 into the locked position. Handle 411 is then released allowing protrusion 702 to sit within recess 701, thereby engaging the latch component to prevent accidental movement of handle 411. The second bias actuator positioned around the circumference of shaft 408 within internal chamber 405 works to bias the position of actuator arm 700, shaft 408 and second clamp head 409 into the locked position. As the second clamp head 409 is offset from longitudinal axis 406 there is sufficient contact area between the inner surface of corner unit 102 and the base of second clamp head 409 to withstand the loads it may be subjected to in use when it is rotated into the locked position.

In order to release two interconnected freight containers 100, 101 the latch component must be released as described previously to allow free rotation of handle 411 and actuator arm 700 in a clockwise direction approximately 90° circumferentially through slot 407. As the second bias actuator works to bias the position of actuator arm 700 and second clamp head 409 into the locked position, extra force must be exerted to overcome the torque provided by coil spring 1201 to move in a clockwise direction. Once shaft 408 and second clamp head 409 have been rotated through approximately 90° clockwise, handle 411 is released and the latch component engaged to prevent accidental movement of handle 411. With second clamp head 409 in the unlocked position as shown in FIG. 9, it can be removed from side aperture 302 of second corner unit 102. The hook shaped first clamp head 404 can then be removed freely from the unit upper and side apertures 301, 302 by release of upper region 1302. Interconnector 400 may then be removed from the first unit 102 to decouple the two adjacent containers 100, 101.

1. An interconnector for coupling two corner units of adjacent ISO freight containers in an end-to-end or side-to-side arrangement, wherein each of the corner units comprises a hollow frame with an aperture which is able to receive a part of the interconnector within the frame, the interconnector comprising:
a main body having a first end, a second end and an internal chamber extending from the second end towards the first end;
a rotatable shaft mounted within the internal chamber;
a first clamp head located substantially at the first end of the main body and a second clamp head located substantially at the second end of the main body;
wherein the second clamp head is fixed to one end of the shaft and is configured to rotate with the shaft; and
a bias actuator to bias rotation of the shaft and the second clamp head relative to the main body;
wherein the first clamp head is substantially hook shaped and is provided in fixed position relative to the main body.

2. The interconnector as claimed in claim 1, wherein the first clamp head further comprises:
a lower hook region which is substantially wedge shaped and an upper hook region which is substantially cube shaped.

3. The interconnector as claimed in claim 2, wherein the lower hook region extends axially from the main body by a length E and the upper hook region extends upwardly and outwardly from the lower hook region by a height A.

4. The interconnector as claimed in claim 2, wherein the lower hook region further comprises:
an upper surface;
a lower surface; and
two side surfaces;
wherein the upper surface is substantially parallel to a longitudinal axis of the main body, the lower surface is oriented at approximately 45° to the longitudinal axis and the two side surfaces are substantially perpendicular to the upper surface.

5. The interconnector as claimed in claim 4, wherein the upper surface of the lower hook region extends axially from the main body by a length C which is approximately 50% of length E.

6. The interconnector as claimed in claim 5, wherein the upper and lower surfaces of the lower hook region are separated by a height B and the two side surfaces are separated by a width D, wherein width D is approximately 85% of height B.

7. The interconnector as claimed in claim 6, wherein length C is approximately 70% of width D.

8. The interconnector as claimed in claim 6, wherein the height A is approximately 60% of height B and 70% of width D.

9. The interconnector as claimed in claim 4, wherein the upper surface, lower surface and two side surfaces of the lower hook region are substantially planar and form abutment surfaces which are able to make contact with an internal surface of a side aperture of the corner unit when the first clamp head is inserted into the corner unit.

10. The interconnector as claimed in claim 3, wherein the upper hook region comprises:
a radial extension of the lower hook region in the form of a protrusion oriented substantially perpendicular to the upper surface of the lower hook region.

11. The interconnector as claimed in claim 3, wherein the upper hook region further comprises:
an upper surface; and
four side surfaces;
wherein the upper surface and four side surfaces are substantially planar and one of the side surfaces is an extension of the upper surface of the lower hook region.

12. The interconnector as claimed in claim 11 wherein another one of the side surfaces is an extension of the lower surface of the lower hook region.

13. The interconnector as claimed in claims 11, wherein three of the four side surfaces of the upper hook region form abutment surfaces which are able to make contact with the internal surface of the upper aperture of the corner unit when the first clamp head is inserted into the corner unit.

14. The interconnector as claimed in claim 1, wherein the second clamp head is aligned offset from a longitudinal axis of the shaft.

15. The interconnector as claimed in claim 1, wherein the second clamp head further comprises:
a dome shape profile having a substantially planar base;
wherein the second clamp head in combination with an end part of the shaft define an L-shaped twistlock arrangement.

16. The interconnector as claimed in claim 15, wherein the substantially planar base of the second clamp head forms an abutment surface which is able to make contact with an internal wall of the corner unit when the second clamp head is rotated in a locked position.

17. The interconnector as claimed in claim 1 further comprising:
a slot extending radially through the main body and aligned perpendicular to the shaft; and
an actuator arm projecting from the shaft and radially outward through the body via the slot, the actuator arm capable of reciprocating movement within the slot to provide rotation of the as the shaft and the second clamp head.

18. The interconnector as claimed in claim 17 wherein the actuator arm comprises a handle movably mounted in a circumferential direction about the main body through the slot.

19. The interconnector as claimed in claim 18 wherein the handle further comprises a first bias actuator positioned to bias the handle in a direction towards the main body.

20. The interconnector as claimed in claim 19 wherein the first bias actuator of the handle comprises a coil spring housed within an internal cavity of the handle, wherein a first end of the spring is attached to the handle and a second end of the spring is attached to the actuator arm.

21. The interconnector as claimed in claim 18, wherein the handle comprises a protrusion and the main body comprises a complementary shaped recess, so that the protrusion is able to fit within the recess and prevent movement of the handle.

22. The interconnector as claimed in claim 17, wherein a second bias actuator comprises a spring attached at one of its ends to the main body and at the opposite end to the actuator arm.

23. The interconnector as claimed in claim 22, wherein the second bias actuator spring is oriented in the internal chamber of the main body and extends circumferentially around the shaft between an internal facing surface of the main body and an outer surface of the shaft.
